(19) United States
(12) Patent Application Publication
(10) Pub. No.: US 2006/0165351 A1
(43) Pub. Date: Jul. 27, 2006

(54) Optical device unit, optical device and microlens array

(75) Inventors: Kenjiro Hamanaka, Osaka-shi (JP); Koichiro Nakamura, Osaka-shi (JP); Satoshi Wada, Osaka-shi (JP)

Correspondence Address: BIRCH STEWART KOLASCH & BIRCH, PO BOX 747, FALLS CHURCH, VA, 22040-0747, US

(73) Assignee: NIPPON SHEET GLASS CO., LTD., Osaka-shi, Osaka (JP)

(21) Appl. No.: 10/517,701

(22) PCT Filed: Jun. 16, 2003
(86) PCT No.: PCT/JP03/07606

§ 371 Date: Jul. 18, 2005

(30) Foreign Application Priority Data
Jun. 14, 2002 (JP) 2002-174757
Jun. 14, 2002 (JP) 2002-174764
Jun. 12, 2003 (JP) 2002-167844
Jun. 12, 2003 (JP) 2003-167853

(51) Int. Cl. G02B 6/32

(52) U.S. Cl. 385/33

(57) ABSTRACT

An optical device unit including optical fibers for input and output, a lens and a reflective/semitransparent optical element, wherein, to enable optical design with a degree of freedom, lenses the number of which is the same as the optical fibers for input and output are provided and the optical fibers, the lenses and the reflective/semitransparent optical element are disposed so that the input/output end of each optical fiber, the optical axis center of the lens and reflection/transmission point on the reflective/semitransparent optical element are aligned.

### TECHNICAL FIELD

The present invention relates to an optical device unit used as an optical demultiplexing module, an optical add/drop module, a gain equalizer, a power monitor or the like, an optical device formed by combining a plurality of the optical device units, and a microlens array constituting the optical device unit or the optical device.

### BACKGROUND ART

An optical demultiplexing module known as an example of a three-port module is arranged in such a ma that, as shown in FIG. 27, refractive index distribution type of rod lenses 101 and 102 are placed on opposite sides of a demultiplexing filter 100, and light with a wavelength of (λ1+λ2) enters an optical fiber 103 and travels through the refractive index distribution type of rod lens 101 to strike the demultiplexing filter 100, light with a wavelength of (λ1) being reflected by the demultiplexing filter 100 to travel through the rod lens 101 and enter an optical fiber 104, light with a wavelength (λ2) passing through the demultiplexing filter 100 and traveling through the rod lens 102 to enter an optical fiber 105.

FIG. 28 shows an optical system using convex lenses and equivalent to the optical system shown in FIG. 27. In this optical system, the distances between the optical fibers 103, 104, and 105 and the lenses 101 and 102 and the distances between the lenses 101 and 102 and the demultiplexing filter 100 are set equal to the focal length f of the lenses.

In ordinary cases, optical fibers are placed and fixed in grooves made of silicon or glass, v-shaped in section and parallel to each other (so-called parallel grooves). If the optical fibers 103 and 104 are placed parallel in this manner, the above-described optical system is an arrangement for receiving reflected light by the optical fiber 104 with maximized efficiency, i.e., a telecentric optical system.

In a case where in the above-described conventional optical system the distance between the optical fibers and the lenses or the distance between the lenses and the demultiplexing filter (optical functional element) are different from the focal distance, there is a problem that, for example, the principal ray of the fight reflected by the demultiplexing filter is inclined from the optical axis of the lens, as shown in FIG. 29, and it is necessary to correspondingly incline the optical fiber on the light receiving side.

That is, in the case of forming the telecentric optical system to avoid inclining the principal ray of the reflected light, it is necessary to set each of the optical fiber-lens distance and the lens-optical functional element distance equal to the focal length of the lens. A problem therefore arises that, in a case where there is a need to increase the lens-optical functional element distance for a reason relating to the structure of the optical functional element for example, the size of the optical system is considerably increased, because the lens is increased in diameter if the focal length of the lens is increased.

An optical demultiplexing module known as an example of a four-port module is arranged in such a manner that as shown in FIG. 30, refractive index distribution type of rod lenses 201 and 202 are placed on opposite sides of a demultiplexing filter 200, and each of a pair of optical fibers 203 and 205 for exit and a pair of optical fibers 204 and 206 for entrance are placed outside the refractive index distribution type of rod lenses 201 and 202.

Light with a wavelength of (λ1+λ2) which has exited from the optical fiber 203 for exit travels through the refractive index distribution type of rod lens 201 and strikes the demultiplexing filler 200. Light with a wavelength of (λ1) is reflected by the demultiplexing filter 200 and travels through the rod lens 201 to enter the optical fiber 204 for entrance, while light with a wavelength (λ2) passes through the demultiplexing filter 200 and travels through the rod lens 202 to enter the optical fiber 205 for exit. Similarly, light with a wavelength of (λ3+λ4) which has exited from the optical fiber 205 for exit travels through the refractive index distribution type of rod lens 202 and strikes the demultiplexing filter 200. Light with a wavelength of (λ4) is reflected by the demultiplexing filter 200 and travels through the rod lens 202 to enter the optical fiber 206 for entrance, while light with a wavelength (λ3) passes through the demultiplexing filter 200 and travels through the rod lens 201 to enter the optical fiber 204.

FIG. 31 shows an optical system using convex lenses and equivalent to the optical system shown in FIG. 30. In this optical system, the distances between the optical fibers 203, 204, 205, and 206 and the lenses 201 and 202 and the distances between the lenses 201 and 202 and the demultiplexing filter 200 are set equal to the focal length f of the lenses.

In ordinary cases, optical fibers are placed and fixed in grooves made of silicon or glass, v-shaped in section and parallel to each other (so-called parallel grooves). If the optical fibers 203 and 204 are placed parallel in this manner, the above-described optical system is an arrangement for receiving reflected light by the optical fiber 204 with maximized efficiency, i.e., a telecentric optical system.

In a case where in the above-described conventional optical system the distance between the optical fibers and the lenses or the distance between the lenses and the demultiplexing filter (optical functional element) is different from the focal distance, there is a problem that, for example, the principal ray of the light reflected by the demultiplexing filter is inclined from the optical axis of the lens, as shown in FIG. 32, and it is necessary to correspondingly incline the optical fiber on the light receiving side.

That is, in the case of forming the telecentric optical system to avoid inclining the principal ray of the reflected light, it is necessary to set each of the optical fiber-lens distance and the lens-optical functional element distance equal to the focal length of the lens. A problem therefore arises that, in a case where there is a need to increase the lens-optical functional element distance for a reason relating to the structure of the optical functional element for example, the size of the optical system is considerably increased, because the lens is increased in diameter if the focal length of the lens is increased.

### DISCLOSURE OF THE INVENTION

An optical device unit in a first aspect of the present invention in which light exiting from a first optical fiber is converged by a lens to travel toward a reflection-type optical element, part or the whole of the light exiting from the first optical fiber is reflected by the reflection-type optical element and is converged by the lens to be coupled to a second optical fiber is arranged in such a manner that the lens is constituted by a first and second lenses adapted to the corresponding optical fibers; the distance between the optical axes of the first and second optical fibers is larger than the distance between the optical axis centers of the first and second lenses; the light exit end of the first optical fiber, the optical axis center of the first lens and the reflection point on the reflection-type optical element are placed in line; and the reflection point on the reflection-type optical element, the optical axis center of the second lens and the entrance end of the second optical fiber are placed in line.

The portion constituted by one lens in the conventional art is thus constituted by two lenses and the distance between the optical axis centers of these lenses and the distance between the optical axes of the optical fibers are suitably adjusted, thereby enabling setting of the magnification of imaging with the optical fibers and the reflection-type optical element in a wide range without restrictions under the restrictive conditions of the conventional telecentric optical system. Optical design with a degree of freedom is thus made possible.

In a case where a multimode optical fiber is used as each optical fiber in the optical device unit in the first aspect of the present invention, it is preferred that the light exit end of the first optical fiber and the reflection point on the reflection-type optical element be in a geometric-optical conjugate relationship with each other, and the light entrance end of the second optical fiber and the reflection point on the reflection-type optical element also be in a geometric-optical conjugate relationship with each other. In a case where a singlemode optical fiber is used as each optical fibers it is preferable to adopt a construction such that a beam waist of a Gaussian beam is formed at each of the light exit end of the first optical fiber, the reflection point on the reflection-type optical element and the light entrance end of the second optical fiber.

It is also preferred that the lens have means for correcting abaxial aberration. As the means for correcting abaxial aberration, one having such a shape as to change the optical power along two axes of the lens perpendicular to each other is conceivable. For example, a so-called toric lens or a diffractive optical element (DOE) designed and manufactured to correct abaxial astigmatism and coma may be used.

As the reflection-type optical element in the first aspect of the present invention, a demultiplexing filter, a movable mirror, a photodetector or the like is conceivable.

An optical device unit in a second aspect of the present invention in which an optical fiber for exit and an optical fiber for entrance are placed in a pair on at least one of left and right sides of a semitransparent optical element; light exiting from the optical fiber for exit on one of the left and right sides is converged by lens means; and the converged light is caused to pass through the semitransparent optical element or reflected by the semitransparent optical element to selectively be coupled to the left and right optical fibers for entrance is arranged in such a manner that the lens means is constituted by a pair of lenses adapted to the pair of optical fibers for exit and entrance; the distance between the optical axes of the pair of optical fibers for exit and entrance is larger than the distance between the optical axis centers of the pair of lenses; and the light exit end of each optical fiber, the optical axis center of the lens corresponding to the optical fiber and the transmission point or the reflection point on the semitransparent optical element are placed in line.

The portion constituted by one lens in the conventional art is thus constituted by two lenses and the distance between the optical axis centers of these lenses and the distance between the optical axes of the optical fibers are suitably adjusted, thereby enabling optical design with a degree of freedom is thus made possible.

In a case where a multimode optical fiber is used as each optical fiber in the optical device unit in the second aspect of the present invention, it is preferred that the light exit end of the first optical fiber and the reflection point on the reflection-type optical element be in a geometric-optical conjugate relationship with each other, and the light entrance end of the second optical fiber and the reflection point on the reflection-type optical element also be in a geometric-optical conjugate relationship with each other. In a case where a singlemode optical fiber is used as each optical fiber, it is preferable to adopt a construction such that a beam waist of a Gaussian beam is formed at each of the light exit end of the first optical fiber, the reflection point on the reflection-type optical element and the light entrance end of the second optical fiber.

It is also preferred that the lens have means for correcting abaxial aberration. As the means for correcting abaxial aberration, one having such a sa as to change the optical power along two axes of the lens perpendicular to each other is conceivable. For example, a so-called toric lens or a diffractive optical element (DOE) designed and manufactured to correct abaxial astigmatism and coma may be used.

As the semitransparent optical element in the second aspect of the present invention, a demultiplexing filter or a reflection/transmission switching element such as a liquid crystal shutter for example is conceivable.

In each of optical devices in the first and second aspects of the present invention, a plurality of the above-described optical device units are arranged linearly or two-dimensionally one adjacent to another, and a microlens array is preferred as a lens in such an optical device or optical device unit.

The microlens array has a plurality of convex lenses formed on a surface of a transparent substrate such as a glass substrate. In the present invention, it is particularly preferable to form lens portions having such shapes that two lenses are partially cut so as to form a pair and the cut portions are brought into abutment on each other.

The microlens array cam also be applied to devices or units other than the above-described optical device unit and optical device.

### BRIEF DESCRIPTION OF THE DRAWINGS

FIGS. 1(a) and 1(b) are diagrams of the constructions of two-port modules in an optical device unit in the first aspect of the present invention, FIG. 1(a) showing an example of use of a singlemode optical fiber, FIG. 1(b) showing an example of use of a multimode optical fiber;

FIG. 2 is a diagram of the construction of an optical device having as its component the optical device unit shown in FIG. 1;

FIG. 3 is a diagram showing another embodiment of the optical device and corresponding to FIG. 2;

FIG. 4 is a diagram showing a view as seen in the direction of arrow A in FIG. 3;

FIG. 5 is a cross-sectional view of a microlens array constituting the optical device shown in FIG. 3;

FIG. 6 is a cross-sectional view of another embodiment of the microlens array;

FIG. 7(a) is a table of design values in a case where the distance between optical fibers is set to 125 μm;

FIG. 7(b) is a table of design values in a case where the distance between optical fibers is set to 250 μm;

FIG. 7(c) is a diagram for explanation of design values;

FIG. 8(a) is a graph showing the relationship between the magnification and the lens diameter in the design values shown in FIG. 7;

FIG. 8(b) is a graph showing the relationship between the magnification and the numerical aperture;

FIG. 8(c) is a diagram showing the relationship between the magnification and the lens-optical functional element distance;

FIG. 9(a) is a table of design values in a case where the distance between optical fibers is set to 125 μm by using a conventional telecentric optical system;

FIG. 9(b) is a table of design values in a case where the distance between optical fibers is set to 250 μm by using the conventional telecentric optical system;

FIG. 9(c) is a diagram of the conventional telecentric optical system for explanation of design values;

FIG. 10(a) is a graph showing the relationship between the lens diameter and the numerical aperture in the design values shown in FIG. 9;

FIG. 10(b) is a graph showing the relationship between the lens diameter and the lens-optical functional element distance;

FIG. 10(c) is a graph showing the relationship between the lens diameter and the beam waist diameter;

FIG. 11 shows the results of measurement of insertion loss in the optical device in the first aspect of the present invention;

FIG. 12 is a diagram of the construction of a four-port module in an optical device unit in the second aspect of the present invention;

FIGS. 13(a) and 13(b) are diagrams for explaining the function of the optical device unit shown in FIG. 12;

FIG. 14 is a diagram for explaining the functions in the case of using a singlemode optical fiber;

FIG. 15 is a diagram of the construction of an optical device having as its component the optical device unit shown in FIG. 12;

FIG. 16 a diagram for explaining the function of an optical device unit according to another embodiment;

FIG. 17 is a diagram of the construction of an optical device according to another embodiment;

FIG. 18 is a diagram of the construction of an optical device according to another embodiment;

FIG. 19 is a diagram showing a view as seen in the direction of arrow A in FIG. 17;

FIG. 20 is a cross-sectional view of a microlens array constituting the optical device shown in FIG. 17;

FIG. 21 is a cross-sectional view showing another embodiment of the microlens array;

FIG. 22(a) is a table of design values in a case where the distance between optical fibers is set to 125 μm;

FIG. 22(b) is a table of design values in a case where the distance between optical fibers is set to 250 μm;

FIG. 22(c) is a diagram for explanation of design values;

FIG. 23(a) is a graph showing the relationship between the magnification and the lens diameter in the design values shown in FIG. 22;

FIG. 23(b) is a graph showing the relationship between the magnification and the numerical aperture;

FIG. 23(c) is a diagram showing the relationship between the magnification and the lens-optical functional element distance;

FIG. 24(a) is a table of design values in a case where the distance between optical fibers is set to 125 μm by using a conventional telecentric optical system;

FIG. 24(b) is a table of design values in a case where the distance between optical fibers is set to 250 μm by using the conventional telecentric optical system;

FIG. 24(c) is a diagram of the conventional telecentric optical system for explanation of design values;

FIG. 25(a) is a graph showing the relationship between the lens diameter and the numerical aperture in the design values shown in FIG. 24;

FIG. 25(b) is a graph shoving the relationship between the lens diameter and the lens-optical functional element distance;

FIG. 25(c) is a graph showing the relationship between the lens diameter and the beam waist diameter;

FIG. 26 shows the results of measurement of insertion loss in the optical device in the second aspect of the present invention;

FIG. 27 is a diagram of the construction of a conventional optical demultiplexing module;

FIG. 28 is a diagram showing an optical system using convex lenses and equivalent to the optical system shown in FIG. 27;

FIG. 29 is a diagram for explaining a problem with the conventional optical demultiplexing module shown in FIG. 27;

FIG. 30 is a diagram of the construction of a conventional optical demultiplexing module;

FIG. 31 is a diagram showing an optical system using convex lenses and equivalent to the optical system shown in FIG. 30; and

FIG. 32 is a diagram for explaining a problem with the conventional optical demultiplexing module shown in FIG. 30.

### BEST MODE FOR CARRYING OUT THE INVENTION

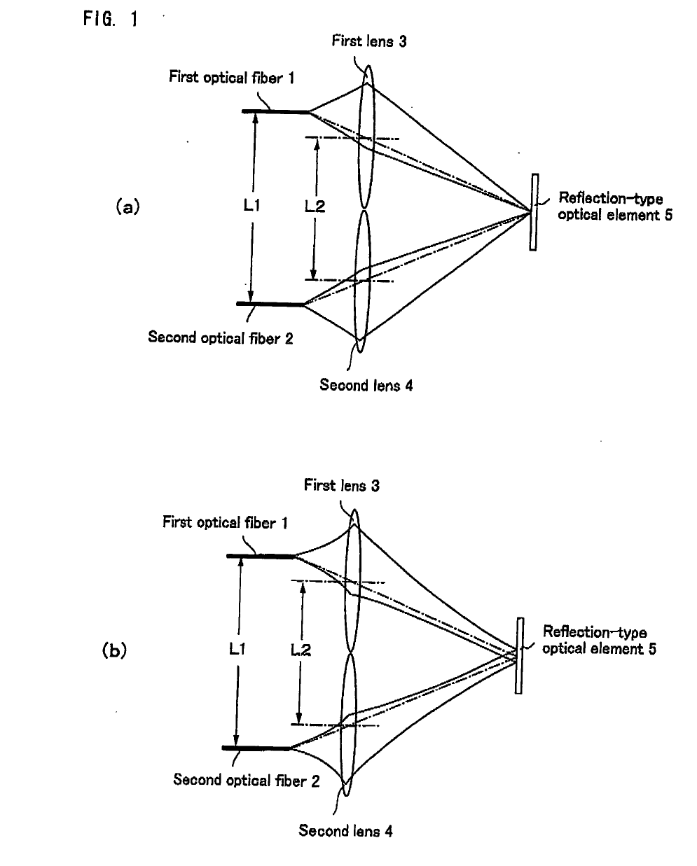

FIGS. 1(a) and 1(b) are diagrams of the constructions of two-port modules in an optical device unit in accordance with a first aspect of the present invention. FIG. 1(a) shows an example of use of a multimode optical fiber, while FIG. 1(b) shows an example of use a singlemode optical fiber.

The optical device unit is constituted by a first optical fiber 1, a second optical fiber 2, a fist lens 3, a second lens 4 and a reflection-type optical element 5. Light which has exited from the first optical fiber 1 is deflected by the first lens 3 to travel toward the reflection-type optical element 5. Part or the whole of the light traveling that has exited from the first optical fiber 1 is reflected by the reflection-type optical element 5. The reflected light is deflected by the second lens 4 to enter the second optical fiber 2.

In the first aspect of the present invention, the distance L1 between the optical axes of the fist and second optical fibers 1 and 2 is larger than the distance L2 between the optical axis centers of the first and second lenses 3 and 4; the light exit end of the first optical fiber 1, the optical axis center of the first lens 3 and the reflection point on the reflection-type optical element 5 are placed in line; and the reflection point on the reflection-type element 5, the optical axis center of the second lens 4 and the entrance end of the second optical fiber 2 are also placed in line.

In the case of using a multimode optical fiber, the distances between the elements are set so that, as shown in FIG. 1(a), the light exit end of the first optical fiber 1 and the reflection point on the reflection-type optical element 5 are in a geometric-optical conjugate relationship with each other and the light entrance end of the second optical fiber 2 and the reflection point on the reflection-type optical element 5 are also in a geometrical conjugate relationship with each other.

In the case of using a singlemode optical fiber, the distances between the elements are set so that, as shown in FIG. 1(b), a beam waist of a Gaussian beam is formed at each of the light exit end of the first optical fiber 1, the reflection point on the reflection-type optical element 5 and the light entrance end of the second optical fiber 2.

The above-described reflection-type optical element 5 may be, for example, a demultiplexing filter, a movable mirror, or a photodetector.

In a case where a demultiplexing filter is used, when light with a plurality of wavelengths enters through the first optical fiber 1, light with a particular one of the wavelengths can be caused to enter the second optical fiber 2. In a case where a micro-electro-mechanical-system (MEMS) minor is used, input of light to the second optical fiber 2 can be turned on and off by moving a movable mirror between a position out of the optical path and a position in the optical path. In a case where a photodetector having a high surface reflectivity is used, the amount of light exiting from the first optical fiber 1 and entering the second optical fiber 2 can be monitored with a small loss.

The lenses 3 and 4 are formed into such a shape that the optical power is changed along two lens axes perpendicular to each other to correct abaxial aberrations. The above-mentioned toric lens and DOE lens correspond to this.

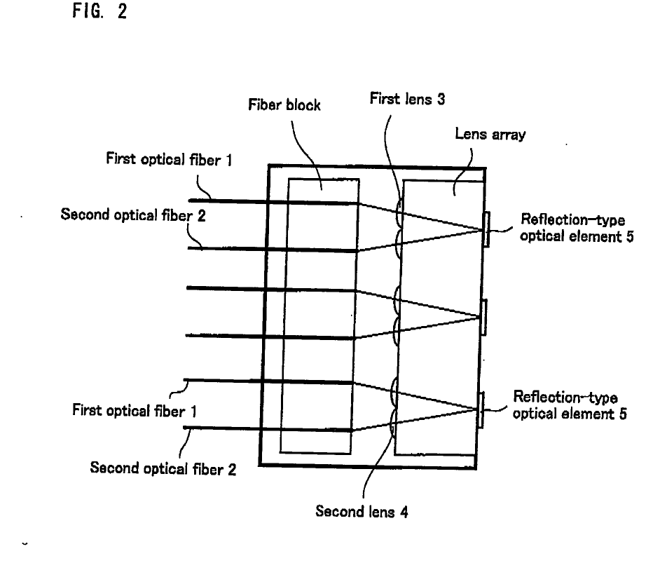

FIG. 2 is a diagram of the construction of an optical device having as its component the optical device unit shown in FIG. 1. In the optical device, a plurality of the above-described optical device units are arranged linearly or two-dimensionally one adjacent to another. The optical device units arranged one adjacent to another may be either identical to or different from each other. For example, if demultiplexing filters having different demultiplexing characteristics are arrayed as the reflection-type optical element 5 of each optical device unit, light with different wavelengths can be caused to enter optical fibers 2 on the entrance side.

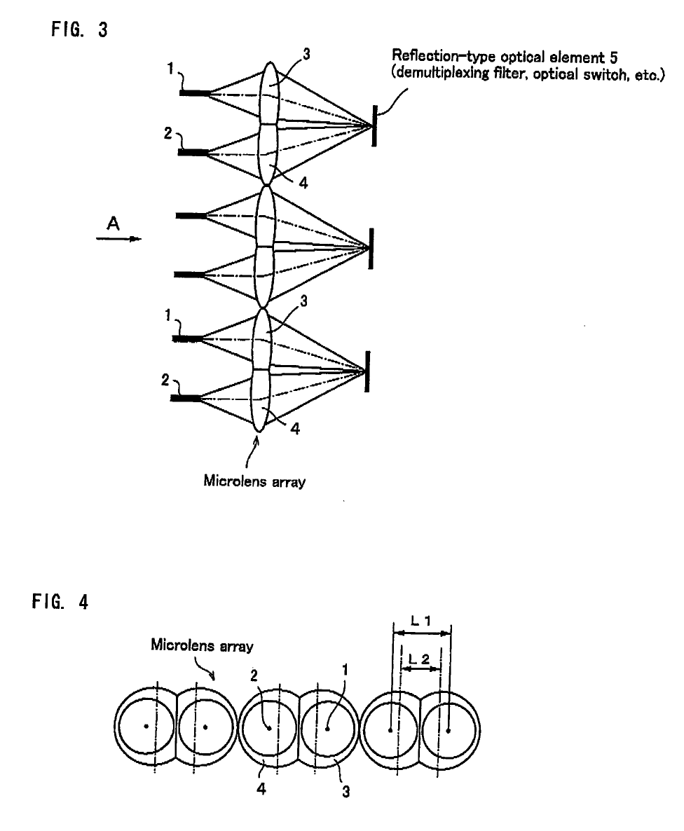

As shown in FIG. 1, adjacent portions of the pair of lenses 3 and 4 constituting the optical device unit are not effectively used as a lens. Therefore, when a microlens array may be made in such a manner that, as shown in FIG. 3 and in FIG. 4 which is a view as seen in the direction of arrow A in FIG. 3, lenses 3 and 4 have such a shape that adjacent portions are removed, more specifically, the lenses 3 and 4 are cut along a bisector perpendicular to a line connecting the centers of the lenses 3 and 4 in a pair as seen in a direction along the optical axis, and the cut portions are brought into abutment on each other.

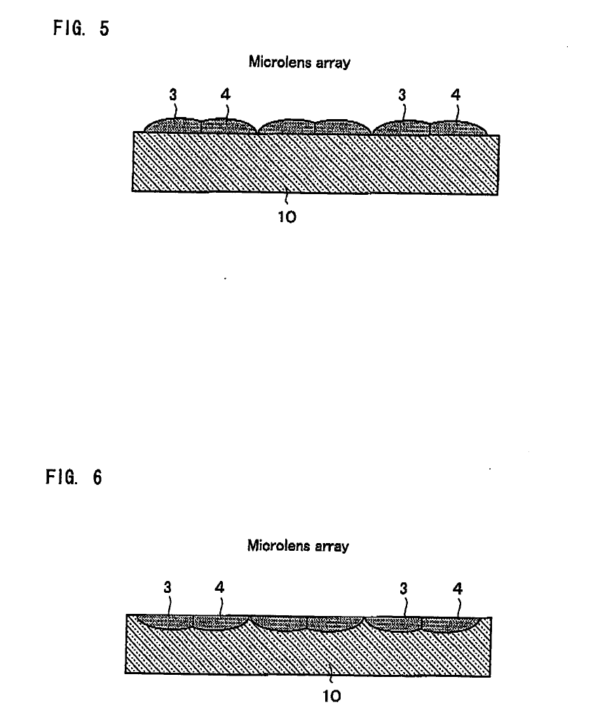

Examples of a structure conceivable as the microlens array constituting the optical device shown in FIGS. 3 and 4 are a structure such as shown in FIG. 5, in which first and second lenses 3 and 4 made of a high-refractive-index resin are protrusively formed on a surface of a transparent substrate 10 such as a glass substrate, and a structure such as shown in FIG. 6, in which recesses are formed in a surface of a transparent substrate 10 and are filled with a high-refractive-index resin to form first and second lenses 3 and 4.

The microlens array having the structure shown in FIG. 5 is manufactured in such a manner that a high-refractive-index resin is laid on a transparent substrate 10 such as a glass substrate, formed by pressing with a glass mold or the like and thereafter set by ultraviolet rays or heat.

The microlens array having the structure shown in FIG. 6 is manufactured in such a manner that a transparent substrate 10 such as a glass substrate is etched through a mask to form recesses, the recesses are filled with a high-refractive-index resin, and the high-refractive-index resin is theater set by ultraviolet rays or heat.

The above-described methods of manufacturing microlens arrays are not exclusively used. An ion exchange method may alternatively be used.

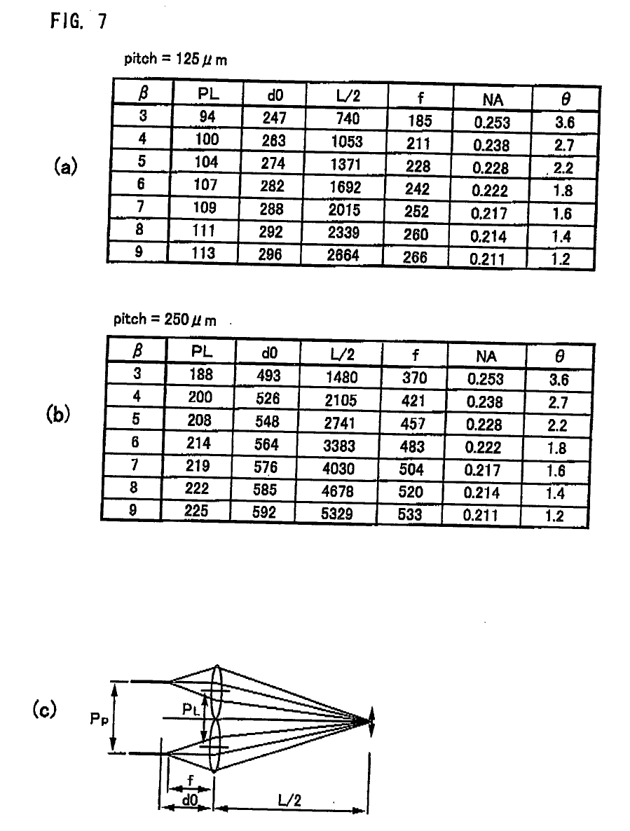

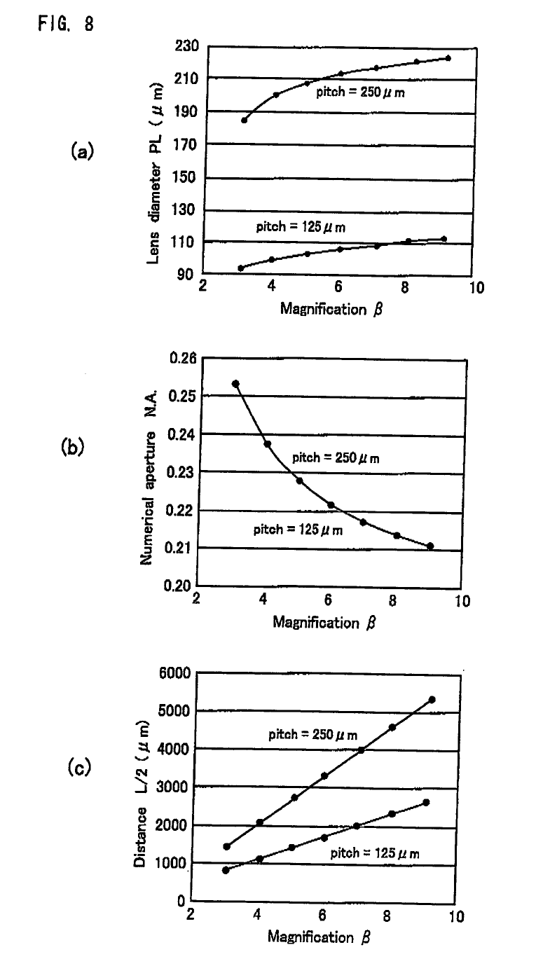

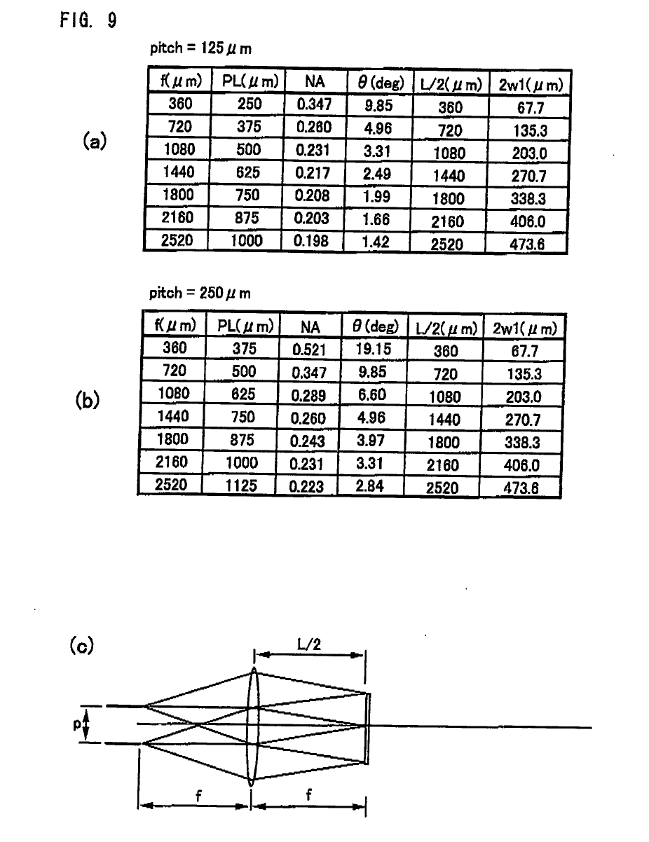

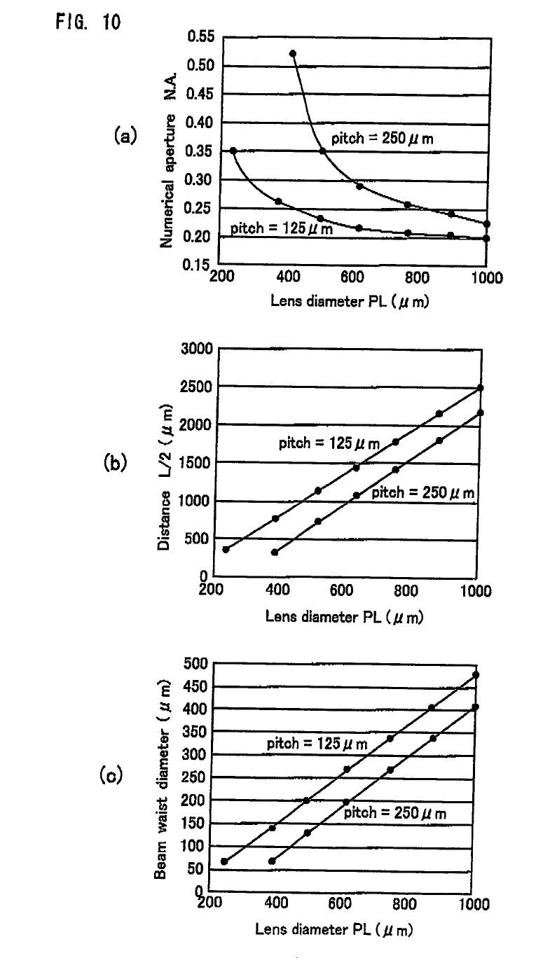

The optical device in the first aspect of the present invention will be described with respect to a concrete example of design numeric values. FIG. 7(a) is a table of design values in a case where the distance between optical fibers is set to 125 μm; FIG. 7(b) is a table of design values in a case where the distance between optical fibers is set to 250 μm; FIG. 7(c) is a diagram for explanation of design values; FIG. 8(a) is a graph showing the relationship between the magnification and the lens diameter in the design values shown in FIG. 7; FIG. 8(b) is a graph showing the relationship between the magnification and the numerical aperture, FIG. 8(c) is a diagram showing the relationship between the magnification and the lens-optical functional element distance; FIG. 9(a) is a table of design values in a case where the distance between optical fibers is set to 125 μm by using a conventional telecentric optical system; FIG. 9(b) is a table of design values in a case where the distance between optical fibers is set to 250 μm by using the conventional telecentric optical system; FIG. 9(c) is a diagram of the conventional telecentric optical system for explanation of design values; FIG. 10(a) is a graph showing the relationship between the lens diameter and the numerical aperture in the design values shown in FIG. 9; FIG. 10(b) is a graph showing the relationship between the lens diameter and the lens-optical functional element distance; and FIG. 10(c) is a graph showing the relationship between the lens diameter and the beam waist diameter.

Referring to FIG. 7, setting the distance between two optical fibers to 125 μm means a situation in which the two optical are placed close to each other (a situation in which any reduction from the set distance is impossible).

If a lens-optical functional element distance L/2 is given in this case, the imaging magnification β and the lens diameter PL are determined. For example, the necessary β determined from FIG. 8(c) is about 4 when L/2 is 1 mm, and about 8.5 when L/2 is 2.5 mm. Lens diameter values determined from FIG. 8(a) in correspondence with these magnification values are PL=100 μm, and 112 μm. The lens diameter is changed only by a little over 10% with respect to the change in magnification. In other words, in the optical device of the present invention, the lens-optical functional element distance can be changed by changing the lens diameter only to a small extent. Therefore, the optical device of the present invention is advantageously used, for example, in a situation where there is a need to increase the lens-optical functional element distance for a reason relating to the optical functional element.

In the case where the distance between optical fibers is set to 250 μm as shown in FIG. 7, the lens-optical functional element distance L/2 can be increased to a value about twice L/2 when the magnification is constant, as shown in FIG. 8(c). Also according to this effect, an improved degree of freedom in designing of the optical device results.

On the other had, in the case of the telecentric system shown in FIGS. 9 and 10, the lens-optical fractional element distance is fixed at L/2=f and the optical fiber-lens distance is also fixed at f, thus reducing the degree of design freedom. In the optical system in which the distance between optical fibers is 125 μm, the lens diameter is about 500 μm when L/2=1 min, and about 1 mm when L/2=2.5 mm. There is a need to double the lens diameter under this condition, resulting in an increase in overall size of the device.

As another mode of implementation in the first aspect of the present invention, an optical device such as shown in FIG. 2, which is constituted by a single-mode optical fiber array, a lens array and a reflection-type optical element, was constructed. The optical system corresponds to that shown in FIG. 1(b). This embodiment is limited to reflection-type optical systems.

Lens elements in the lens array were formed by forming a resin. A mode for forming a lens array, in which pairs of recesses corresponding to the pairs of lens elements were arranged, was prepared. A mold releasing agent was applied to this mold and an ultraviolet curing type of epoxy resin was thereafter flown on the mold and pressed against a glass substrate. In this state the resin was set by being irradiated with ultraviolet rays, and the mold was thereafter released to obtain the lens array. The reflection-type optical element was formed by depositing Al film on the back surface of the glass substrate of the lens array.

The diameter PL of the manufactured lens element was set to 500 μm and the distance L2 between each pair of lenses was set to 500 μm That is, each pair of lens elements are placed in positions close to each other to form the optical system shown in FIG. 1(b). The focal length f of the lens element was 1.075 mm at a wavelength of 1550 nm and the numerical aperture was 0.233. The mode field diameter of the single-mode optical fibers used is 10.5 μm.

Assembly of the optical device was performed by a procedure described below. The distance L/2 between the lens army and the reflecting surface is set by adjusting the thickness of the lens array substrate, and light with a wavelength of 1550 nm is caused to enter from the fit optical fiber 1. This light enters the reflection-type optical element 5 through the first lens 3. The positions of the optical fibers (the distance L1 between the optical axes of the optical fibers and the distance d0 between the optical fiber end surfaces and the lenses) and the tilt angle of the reflection-type optical element were adjusted so that the insertion loss when the light that entered the reflection-type optical element 5 and was reflected by the reflection-type optical element 5 was converged by the second lens 4 to couple to the second optical fiber 2 was minimized.

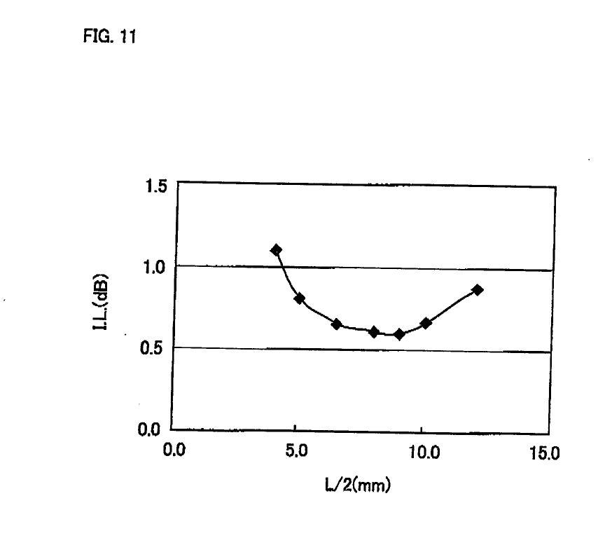

The insertion loss when the distance L/2 between the lenses and the reflection-type optical elements in this optical device was changed was measured. Table 1 shows computed values of the sizes of the portions with respect to different values 4.0, 6.0 and 8.0 mm of L/2. FIG. 11 shows the results of measurement of the insertion loss. When L/2 was in the rage from 6 to 10 mm, the insertion loss IL was low. When L/2=9 mm, 0.6 dB was obtained as the minimum value of IL. However, this IL is an excessive insertion loss converted on the assumption that the reflectivity of the reflecting surface is 100%.

TABLE 1

| | | | |
|---|---|---|---|
| Lens-reflecting surface distance | 4000 | 6000 | 8000 |
| L/2 (μm) | | | |
| Optical fiber end surface-lens | 1083 | 1089 | 1097 |
| distance d0 (μm) | | | |
| Magnification β | 5.5 | 7.3 | 9.0 |
| Distance between optical fiber | 635 | 591 | 569 |
| optical axes L1 (μm) | | | |
| Tilt angle of reflecting surface | 3.58 | 2.39 | 1.79 |
| (deg) | | | |
| Beam waist radius W1 (μm) | 100 | 98 | 94 |
| Effective NA Naeff | 0.168 | 0.188 | 0.197 |

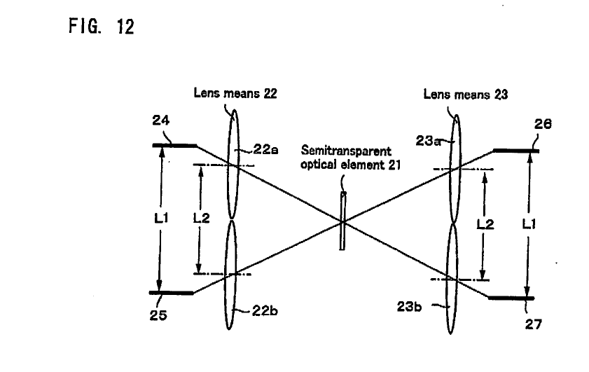

Description will next be made of the second aspect of the present invention. FIG. 12 is a diagram of the construction of a four-port module in an optical device unit in the second aspect of the present invention. In the optical device unit, lens means 22 and 23 are placed on left and right sides of a semitransparent optical element opposite from each other, and an optical fiber 24 for exit and an optical fiber 25 for entrance are provided in a pair outside the lens means 22, while an optical fiber 26 for exit and an optical fiber 27 for entrance are provided in a pair outside the lens means 23.

In the second aspect of the present invention in particular, the lens means 22 and 23 are respectively constituted by a pair of lenses 22a and 22b and a pair of lenses 23a and 23b adopted to the corresponding optical fibers; the distance L1 between the optical axes of the pair of optical fibers 24 and 25 or 26 and 27 for exit and entrance is larger than the distance L2 between the optical axis centers of the pair of lenses 22a and 22b or 23a and 23b; and the light entrance end or exit end of each optical fiber, the optical axis center of the lens corresponding to the optical fiber and the transmission point or the reflection point on the semitransparent optical element are placed in line.

That is, the light exit end or the light entrance end of each of the optical fibers 24, 25, 26, and 27 and the transmission point or the reflecting point on the semitransparent optical element 25 are in a geometric-optical conjugate relationship with each other.

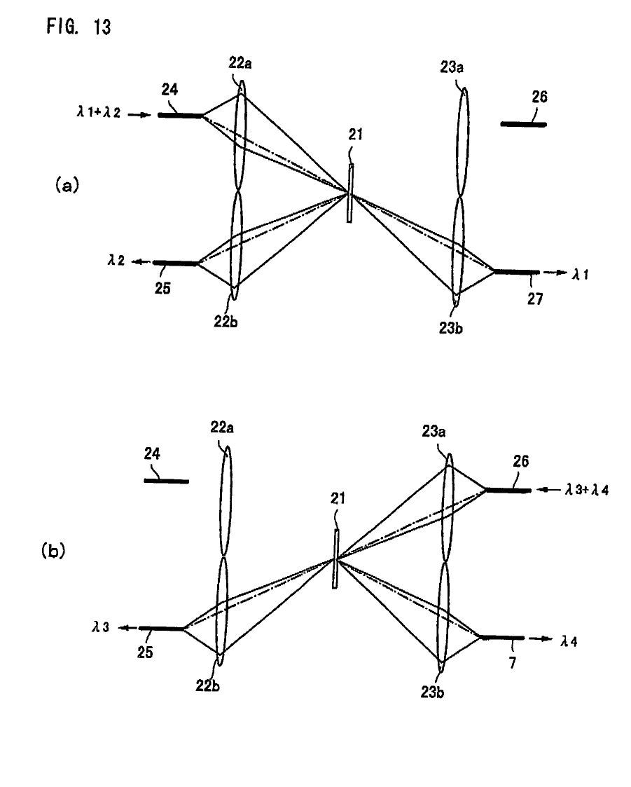

The function in a case where a demultiplexing filter is used as the above-described semitransparent optical element 21 will be described with reference to FIG. 13. As shown in (a), light including a plurality of wavelength (λ1+λ2) enters the demultiplexing filter from the fiber for exit (multimode optical fiber) 24, and only light with a particular one of the wavelengths (λ1) in this light passes through the demultiplexing filter and enters the optical fiber 27 for entrance. If the demultiplexing filter is designed to reflect light with the particular one of the wavelengths (λ2), reflected light (λ2) simultaneously enters the optical fiber 25 for entrance.

Also, as shown in (b), light including a plurality of wavelengths (λ3+λ4) enters the demultiplexing filter from the fiber for exit (multimode optical fiber) 26, and only light with a particular one of the wavelengths (λ3) passes through the demultiplexing filter and enters the optical fiber 27 for entrance. If the demultiplexing filter is designed to reflect light with the particular one of the wavelengths (λ4), reflected light (λ4) simultaneously enters the optical fiber 7 for entrance.

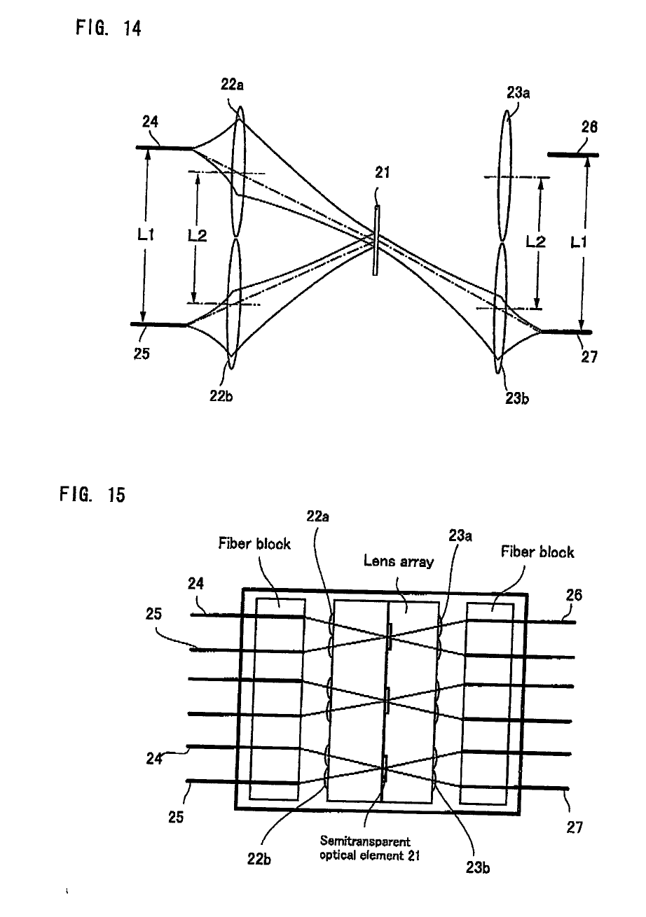

In the case of using a singlemode optical fiber, the distances between the elements are set so that as shown in FIG. 14, a beam waist of a Gaussian beam is formed at each of the light exit ends and the light entrance ends of the optical fibers 24, 25, 26, and 27, and the transmission point and the reflection point on the semitransparent optical element 21.

A reflection/transmission switching element such as a liquid crystal shutter other than the demultiplexing filter may be used as the above-described reflection-type optical element 21. If a reflection/transmission switching element is used, a switching operation can be performed such that light which has exited from the optical fiber 24 is caused to enter one of the optical fibers 25 and 27 according to an electrical signal input.

The above-described lens means 22 and 23 are formed into such a shape that the optical power is changed along two lens axes perpendicular to each other to correct abaxial aberrations. The above-mentioned toric lens and DOE lens correspond to this.

FIG. 15 is a diagram of the construction of an optical device having as its component the optical device unit shown in FIG. 12. In the optical device, a plurality of the above-described optical device units are arranged linearly or two-dimensionally one adjacent to another. The optical device units arranged one adjacent to another may be either identical to or different from each other. For example, if demultiplexing filters having different demultiplexing characteristics are arrayed, light with different wavelengths can be caused to enter optical fibers 24, 25, 26, and 27 on the entrance side.

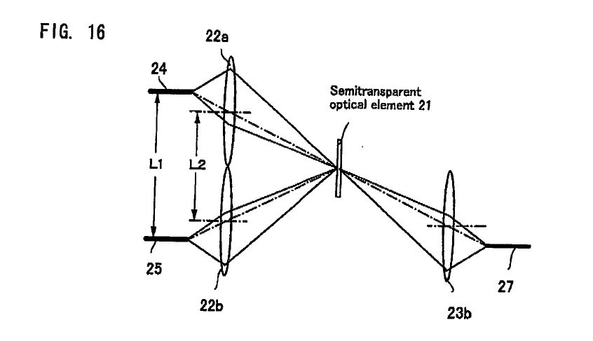

FIG. 16 a diagram of the construction of a three-port module in an optical device unit in accordance with the present invention. In the optical device unit is constituted by a first optical fiber 24, a second optical fiber 25, a first lens 22a, a second lens 22b, a semitransparent optical element 21 and a fourth optical fiber 27. Light which has exited from the first optical fiber 24 is converged by the first lens 22a to travel toward the semitransparent optical element 21. Part (wavelength λ1) of the light that has exited from the first optical fiber 24 is reflected by the semitransparent optical element 21 and the reflected light is converged by the second lens 22b to enter the second optical fiber 25, while light which (wavelength λ2) has passed through the semitransparent optical element 21 enters the fourth optical fiber 27.

Also in this embodiment, the distance L1 between the optical axes of the pair of first and second optical fibers 24 and 25 is larger than the distance L2 between the optical axis centers of the pair of first and second lenses 22a and 22b; the light exit end of the first optical fiber 24, the optical axis center of the first lens 22a and the reflection point (transmission point) on the semitransparent optical element 21 are placed in line; and the reflection point (transmission point) on the semitransparent optical element 21, the optical axis center of the second lens 22b and the entrance end of the second optical fiber 25 are placed in line. The light entrance ends of the third optical fiber 26 and the fourth optical fiber 27 are in positions such as to a symmetrical relationship with the first optical fiber 24 and the second optical fiber 25 about the semitransparent optical element 21.

Settings of the distances between the elements in the case of using a multimode optical fiber as each optical fiber and the case of using a singlemode optical fiber as each optical fiber are the same as those in the above-described embodiments, and an example of a reflection-type optical element 25 is the same as that in the above-described embodiments.

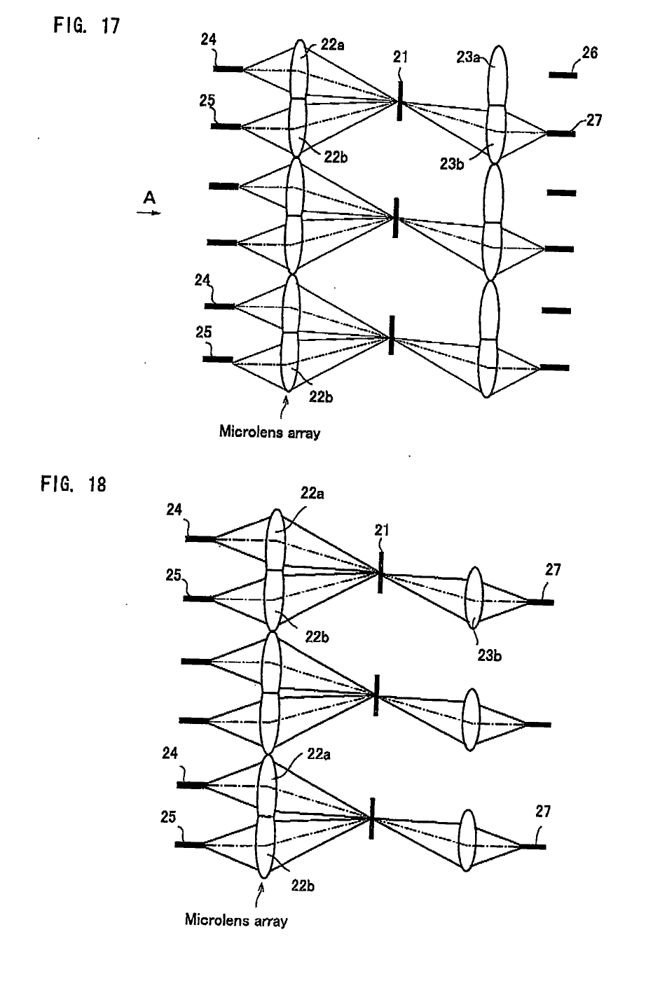

As shown in FIG. 12, the adjacent portions of the pair of lenses 22a and 22b constituting the optical device unit are not effectively used as a lens. Therefore, a microlens array may be made in such a manner that, as shown in FIG. 17 (four-port), FIG. 18 (three-port), and FIG. 19 which is a view as seen in the direction of arrow A in FIG. 17, lenses 22a and 22b have such a shape that adjacent portions are removed, more specifically, the lenses 22a and 22b are cut long a bisector perpendicular to a line connecting the centers of the lenses 22a and 22b in a pair as seen in a direction along the optical axis, and the cut portions are brought into abutment on each other.

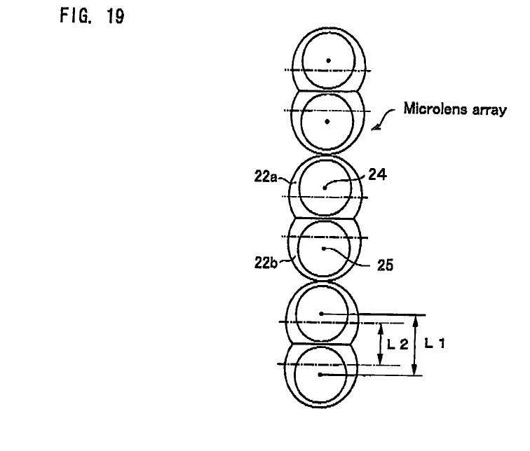

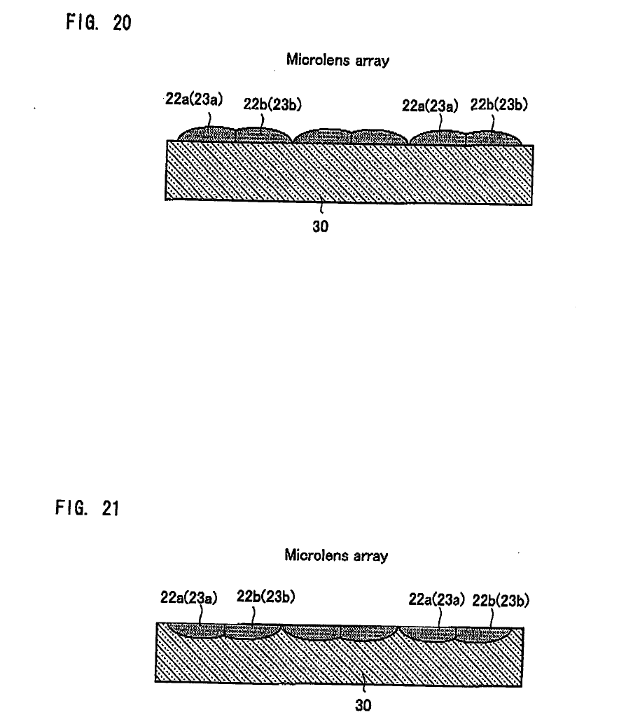

Examples of a structure conceivable as the microlens array constituting the above-described optical device are a structure such as shown in FIG. 20, in which a pair of lenses 22a and 22b (23a and 23b) made of a high-refractive-index resin are protrusively formed on a surface of a transparent substrate 30 such as a glass substrate, and a structure such as shown in FIG. 21, in which recesses are formed in a surface of a transparent substrate 30 and are filled with a high-refractive-index resin to form a pair of lenses 22a and 22b (23a and 23b).

The microlens array having the structure shown in FIG. 20 is manufactured in such a manner that a high-refractive-index resin is laid on a transparent substrate 30 such as a glass substrate, formed by pressing with a glass mold or the like and thereafter set by ultraviolet rays or heat.

The microlens array having the structure shown in FIG. 21 is manufactured in such a manner that a transparent substrate 30 such as a glass substrate is etched through a mask to form recesses, the recesses are filled with a high-refractive-index resin, and the high-refractive-index resin is thereafter set by ultraviolet rays or heat.

The above-described methods of manufacturing microlens arrays are not exclusively used. An ion exchange method may alternatively be used.

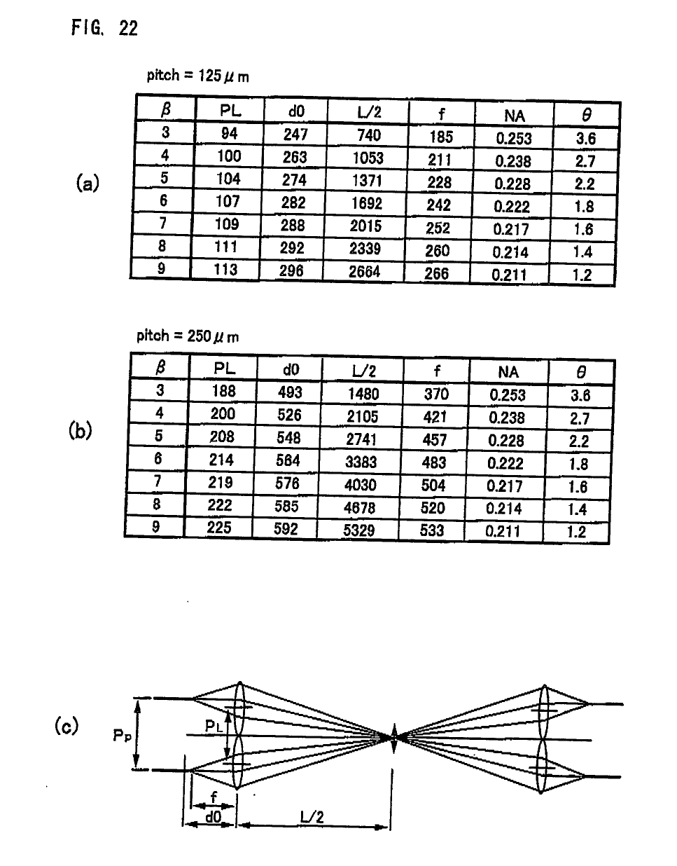

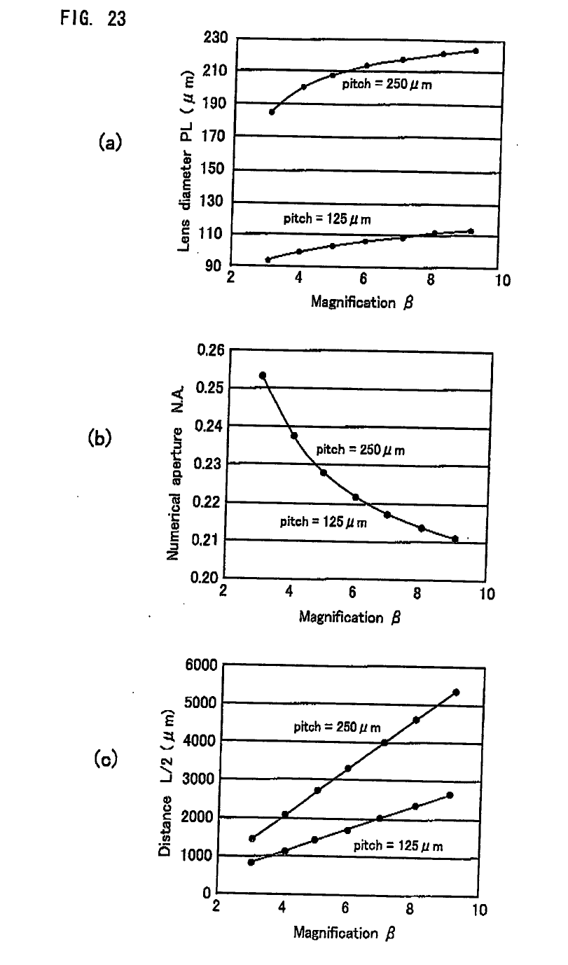

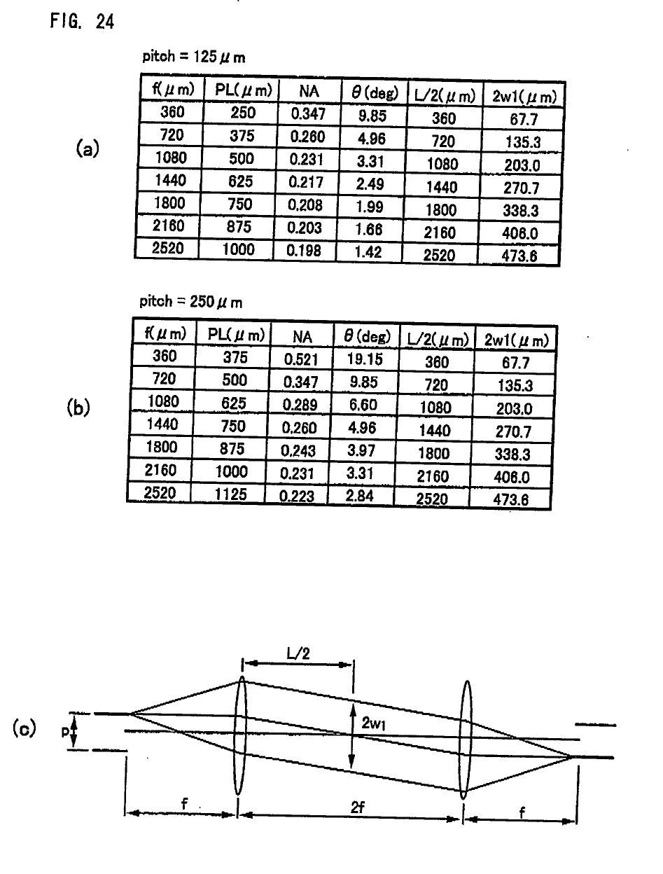

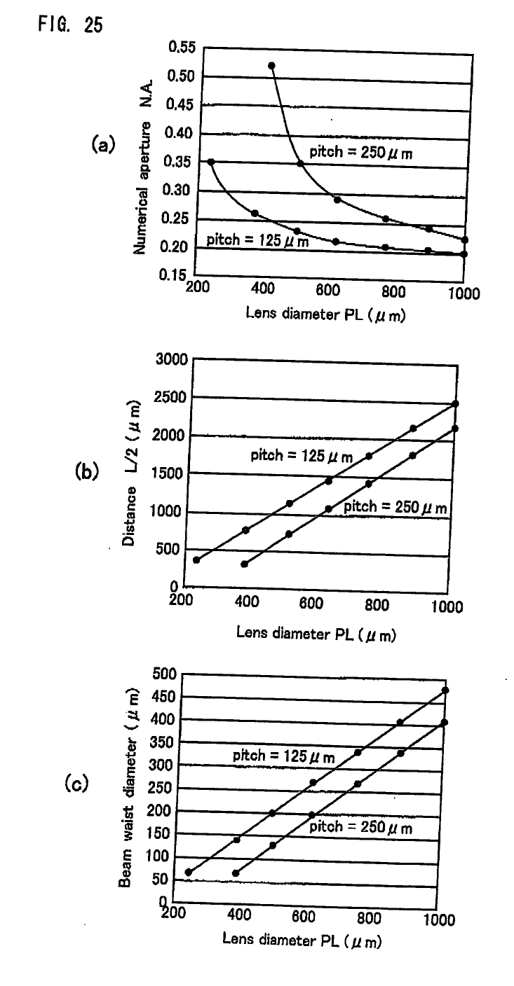

The optical device in accordance with the present invention will be described with respect to a concrete example of design numeric values. FIG. 22(a) is a table of design values in a case where the distance between optical fibers is set to 125 μm; FIG. 22(b) is a table of design values in a case where tile distance between optical fibers is set to 250 μm; FIG. 22(c) is a diagram for explanation of design values; FIG. 23(a) is a graph showing the relationship between the magnification and the lens diameter in the design values shown in FIG. 22; FIG. 23(b) is a graph showing the relationship between the magnification and the numerical aperture; FIG. 23(c) is a diagram showing the relationship between the magnification and the lens-optical functional element distance; FIG. 24(a) is a table of design values in a case where the distance between optical fibers is set to 125 μm by using a conventional telecentric optical system; FIG. 24(b) is a table of design values in a case where the distance between optical fibers is set to 250 μm by using the conventional telecentric optical system; FIG. 24(c) is a diagram of the conventional telecentric optical system for explanation of design values; FIG. 25(a) is a graph showing the relationship between the lens diameter and the numerical aperture in the design values shown in FIG. 24; FIG. 25(b) is a graph showing the relationship between the lens diameter and the lens-optical functional element distance; and FIG. 25(c) is a graph showing the relationship between the lens diameter and the beam waist diameter.

Referring to FIG. 22, setting the distance between two optical fibers to 125 μm means a situation in which the two optical are placed close to each other (a situation in which any reduction from the set distance is impossible).

If a lens-optical functional element distance L/2 is given in this case, the imaging magnification β and the lens diameter PL are determined. For example, the necessary β determined from FIG. 23(c) is about 4-fold when L/2 is 1 mm, and about 8.5-fold when L/2 is 2.5 mm. Lens diameter values determined from FIG. 23(a) in correspondence with these magnification values are PL=100 μm, and 112 μm. The lens diameter is changed only by a little over 10% with respect to the change in magnification. In other words, in the optical device of the present invention, the lens-optical functional element distance can be changed by changing the lens diameter only to a small extent. Therefore, the optical device of the present invention is advantageously used, for example, in a situation where there is a need to increase the lens-optical functional element distance for a reason relating to the optical functional element.

In the case where the distance between optical fibers is set to 250 μm as shown in FIG. 22, the lens-optical functional element distance L/2 can be increased to a value about twice L/2 when the magnification is constant, as shown in FIG. 23(c). Also according to this effect, an improved degree of freedom in designing of the optical device results.

On the other hand, in the case of the telecentric system shown in FIGS. 24 and 25, the lens-optical functional element distance is fixed at L/2=f and the optical fiber-lens distance is also fixed at f, thus reducing the degree of design freedom. In the optical system in which the distance between optical fibers is 125 μm, the lens diameter is about 500 μm when L/2=1 mm, and about 1 mm when L/2=2.5 mm. There is a need to double the lens diameter under this condition, resulting in an increase in overall size of the device.

As another embodiment of the present invention, an optical device such as shown in FIG. 15, which is constituted by single-mode optical fiber arrays, lens arrays and semitransparent optical elements, was constructed. The optical system corresponds to that shown in FIG. 14. This embodiment is limited to transmission-type optical systems.

Lens elements in the lens array were formed by forming a resin. A mode for forming a lens array, in which pairs of recesses corresponding to the pairs of lens elements were arranged, was prepared. A mold releasing agent was applied to this mold and an ultraviolet curing type of epoxy resin was thereafter flown on the mold and pressed against a glass substrate. In this state the resin was set by being mediated with ultraviolet rays, and the mold was thereafter released to obtain the lens array. The semitransparent optical element, which is a partially reflecting mirror reflecting 90% at a wavelength of 1550 nm whie allowing 10% to pass therethrough, was formed by depositing Au film on the back surluce of the glass substrate of one of the lens arrays.

The diameter PL of the manufactured lens element was set to 500 μm and the distance L2 between each pair of lenses was set to 500 μm. That is, each pair of lens elements are placed in positions close to each other to form the optical system shown in FIG. 14. The focal length f of the lens element was 1.075 mm at a wavelength of 1550 nm and the numerical aperture was 0.233. The mode field diameter of the single-mode optical fibers used is 10.5 μm.

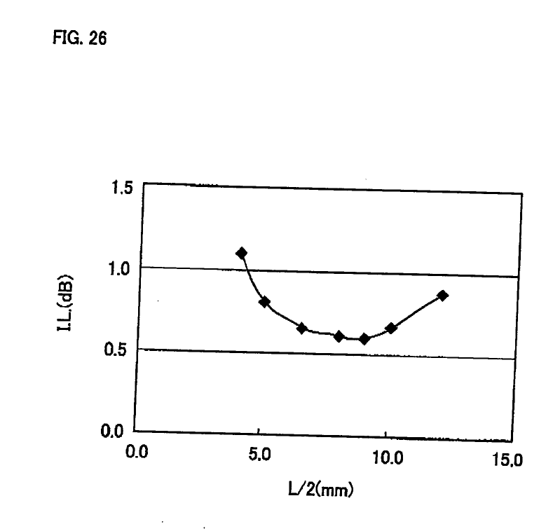

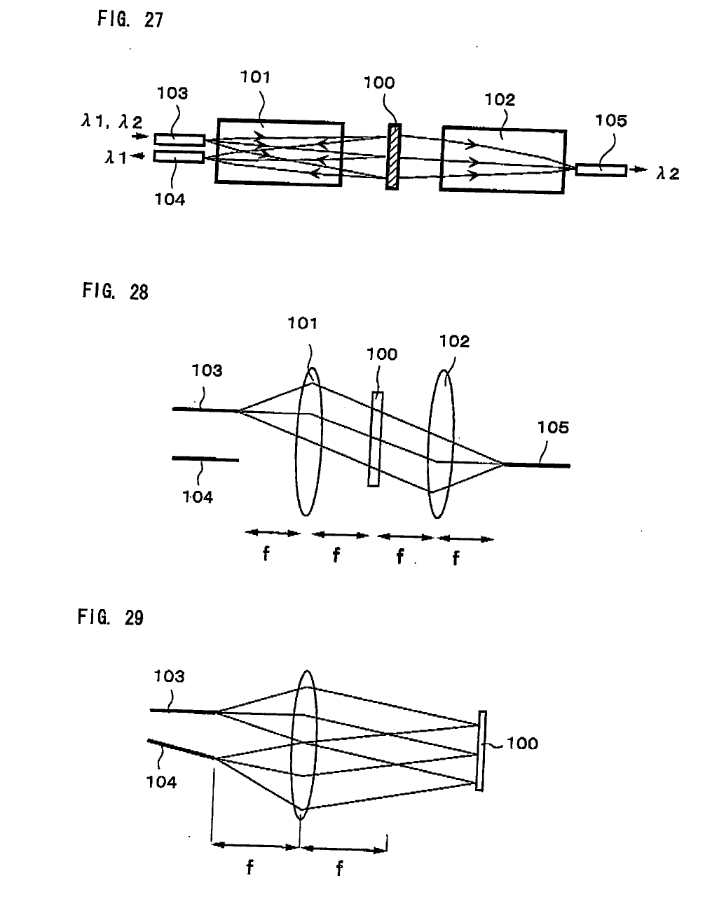

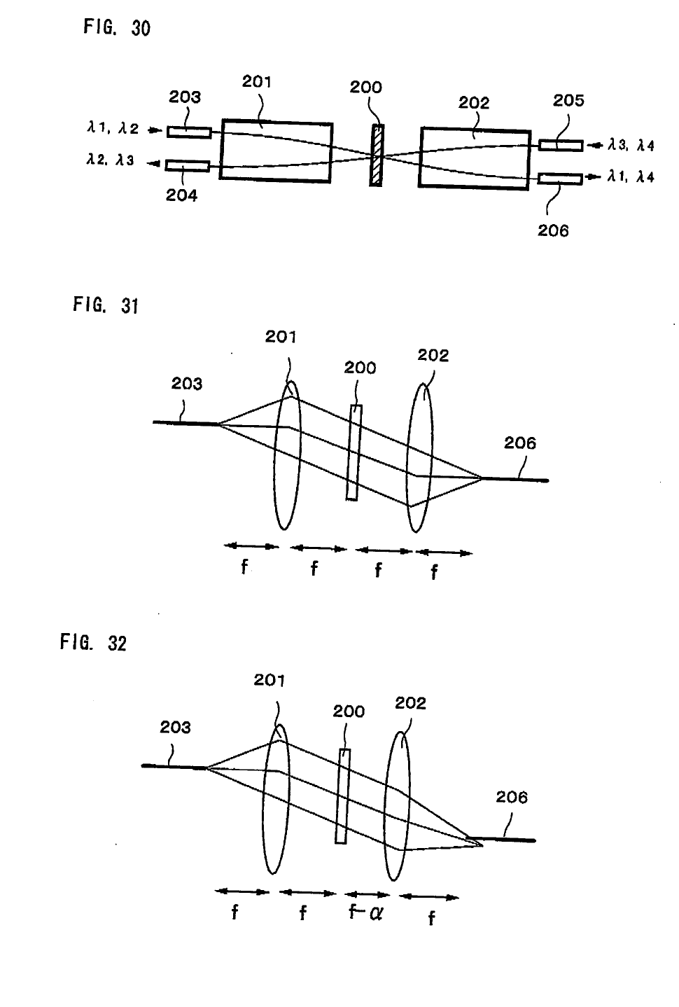

Assembly of the optical device was performed by a procedure described below. The distance L/2 between the two lens arrays and the semitransparent surface is set by adjusting the thickness of the lens array substrates (the thickness of the substrates of the two lens array being set equal to each other), and light with a wavelength of 1550 nm is caused to enter from the optical fiber 24. This light enters the semitransparent optical element 21 through the lens 22a. The positions of the optical fibers (the distance L1 between the optical axes of the optical fibers and the distance d0 between the optical fiber end surfaces and the lenses) to the lens and the tilt angle of the semitransparent optical element were adjusted so that the insertion loss when the light that entered the semitransparent optical element 21 through the lens 22a and was reflected by the semitransparent optical element 21 was converged by the lens 22b to couple to the optical fiber 25 was minimized. Subsequently, the positions of the optical fibers are adjusted so that the light passing trough the semitransparent optical element 21 enters the lens 23b and couples to the optical fiber 27 and the insertion loss is minimized. The insertion loss when the distance L/2 between the lenses and the semitransparent optical elements in this optical device was changed was measured. Table 2 shows computed values of the sizes of the portions with respect to different values 4.0, 6.0 and 8.0 mm of L/2. FIG. 26 shows the results of measurement of the insertion loss. When L/2 was in the range from 6 to 10 mm, the insertion loss IL was low. When L/2=9 mm, 0.6 dB was obtained as the minimum value of IL. However, this IL is an excessive insertion loss obtained by removing the attenuation by reflection on the semitransparent surface. The same characteristics were also obtained with respect to the transmission side.

TABLE 2

| | | | |
|---|---|---|---|
| Lens-reflecting surface distance | 4000 | 6000 | 8000 |
| L/2 (μm) | | | |
| Optical fiber end surface-lens | 1083 | 1089 | 1097 |
| distance d0 (μm) | | | |
| Magnification β | 5.5 | 7.3 | 9.0 |
| Distance between optical fiber | 635 | 591 | 569 |
| optical axes L1 (μm) | | | |
| Tilt angle of reflecting surface | 3.58 | 2.39 | 1.79 |
| (deg) | | | |
| Beam waist radius W1 (μm) | 100 | 98 | 94 |
| Effective NA Naeff | 0.168 | 0.188 | 0.197 |

### INDUSTRIAL APPLICABILITY

According to the present invention, as described above, an imaging optical system is formed. Therefore the degree of freedom in setting the distances between the optical elements is high and the range of use is wide.

Also, the spacings between the optical elements can be easily formed uniformly with high accuracy, and there is no need for a high aligning technique.

In particular, a microlens array in which only lens portions capable of functioning effectively are combined is formed by cutting adjacent portions of each pair of lenses, thus achieving a reduction in size of the device.

1. An optical device unit in which light exiting from a first optical fiber is converged by a lens to travel toward a reflection-type optical element, part or the whole of the light exiting from the first optical fiber is reflected by the reflection-type optical element and is converged by the lens to be coupled to a second optical fiber, the optical device unit being characterized in that the lens is constituted by a first and second lenses adapted to the corresponding optical fibers; the distance between the optical axes of the first and second optical fibers is larger than the distance between the optical axis centers of the first and second lenses; the light exit end of the first optical fiber, the optical axis center of the first lens and the reflection point on the reflection-type optical element are placed in line; and the reflection point on the reflection-type optical element, the optical axis center of the second lens and the entrance end of the second optical fiber are placed in line.

2. The optical device unit according to claim 1, characterized in that the optical fibers are multimode optical fibers; the light exit end of the first optical fiber and the reflection point on the reflection-type optical element are in a geometric-optical conjugate relationship with each other; and the light entrance end of the second optical fiber and the reflection point on the reflection-type optical element are also in a geometric-optical conjugate relationship with each other.

3. The optical device unit according to claim 1, characterized in that the optical fibers are singlemode optical fibers, and a beam waist of a Gaussian beam is formed at each of the light exit end of the first optical fiber, the reflection point on the reflection-type optical element and the light entrance end of the second optical fiber.

4. The optical device unit according to claim 1, characterized in that the lens has means for correcting abaxial aberration.

5. The optical device unit according to claim 4, characterized in that the means for correcting abaxial aberration has such a shape as to change the optical power along two axes of the lens perpendicular to each other.

6. The optical device unit according to claim 1, characterized in that the reflection-type optical element is one of a demultiplexing filter, a movable mirror and a photodetector.

7. An optical device characterized in that a plurality of the optical device units according to claim 1 are arranged linearly or two-dimensionally one adjacent to another.

8. An optical device unit in which an optical fiber for exit and an optical fiber for entrance are placed in a pair on at least one of left and right sides of a semitransparent optical element opposite; light exiting from the optical fiber for exit on one of the left and right sides is converged by lens means; and the converged light is caused to pass through the semitransparent optical element or reflected by the semitransparent optical element to selectively be coupled to the left and right optical fibers for entrance, the optical device unit being characterized in that the lens means is constituted by a pair of lenses adapted to the pair of optical fibers for exit and entrance; the distance between the optical axes of the pair of optical fibers for exit and entrance is larger than the distance between the optical axis centers of the pair of lenses; and the light exit end or the light entrance end of each optical fiber, the optical axis center of the lens corresponding to each optical fiber and the transmission point or the reflection point on the semitransparent optical element are placed in line.

9. The optical device unit according to claim 8, characterized in that the optical fibers are multimode optical fibers; the light exit end of the optical fiber for exit and the transmission point or the reflection point on the semitransparent optical element are in a geometric-optical conjugate relationship with each other; and the light entrance end of the optical fiber for entrance and the transmission point or the reflection point on the semitransparent optical element are also in a geometric-optical conjugate relationship with each other.

10. The optical device unit according to claim 8, characterized in that the optical fibers are singlemode optical fibers, and a beam waist of a Gaussian beam is formed at each of the light exit end of the optical fiber for exit, the transmission point or the reflection point on the semitransparent optical element and the light entrance end of the optical fiber for entrance.

11. The optical device unit according to claim 8, characterized in that the lens has means for correcting abaxial aberration.

12. The optical device unit according to claim 11, characterized in that the means for correcting abaxial aberration has such a shape as to change the optical power along two axes of the lens perpendicular to each other.

13. The optical device unit according to claim 8, characterized in that the semitransparent optical element is a demultiplexing filter or a reflection/transmission switching element such as a liquid crystal shutter.

14. An optical device characterized in that a plurality of the optical device units according to claim 8 are arranged linearly or two-dimensionally one adjacent to another.

15. A microlens array having a plurality of lens portions formed on a surface of a transparent substrate, the microlens array being characterized in that two lens in the lens portions form a pair, and the lenses forming a pair have such shapes that the lenses are cut along a bisector perpendicular to a line connecting the centers of the lenses as seen in a direction along the optical axis, and the cut portions are brought into abutment on each other.
